(19) United States
(12) Patent Application Publication
(10) Pub. No.: US 2022/0240462 A1
(43) Pub. Date: Aug. 4, 2022

(54) DEVICE FOR COLLECTING SAP FROM A TREE

(71) Applicant: Les Equipements D'Erabliere C.D.L. Inc, Sainte-Claire (CA)

(72) Inventors: Christian GOSSELIN, Levis (CA); Martin CHABOT, Sainte-Claire (CA)

(21) Appl. No.: 17/590,876

(22) Filed: Feb. 2, 2022

Related U.S. Application Data
(60) Provisional application No. 63/144,501, filed on Feb. 2, 2021.

(51) Int. Cl. A01G 23/10

(52) U.S. Cl. CPC A01G 23/10

(57) ABSTRACT

A device for collecting sap from a tapped hole in a tree and directing the sap to a sap collecting tube that is removably connectable to the device. The device comprises a tapping member with a first portion that is removably insertable into the tree and a second portion extending outside the tree when the first portion is inserted into the tree and a connecting member with a connecting portion adapted to be mounted to the second portion of the tapping member and a fitting portion adapted to receive the sap collecting tube. The device also comprises a securing means for locking the connecting member relative to the tapping member such that longitudinal movement of the connecting member is prevented and a seal mounted between the second portion of the tapping member and the connecting portion of the connecting member.

### CROSS REFERENCE TO RELATED APPLICATION

This application claims priority under 35 U.S.C. § 119 based on U.S. Provisional Application No. 63/144,501, filed Feb. 2, 2021, the contents of which are hereby incorporated by reference herein.

### FIELD

The present disclosure relates to a device for collecting sap from a tapped hole in a tree and directing the sap to a sap collecting tube that is removably connectable to the device.

### BACKGROUND

The maple syrup industry, which has produced maple syrup in an artisanal way for a hundred years until the 1960s, has undergone transformation towards industrialization in order to initiate an increase in production performance and lower production costs which became prohibitive.

The classical way of harvesting sap was using buckets hanging from the trees. Thereafter, each bucket was to be emptied one by one into a large container, which was pulled by a horse, a tractor or another type of all-terrain vehicle into the sugar bush. Subsequently, the sap from the large container was sent to the sugar shack in order to be boiled using an evaporator to obtain a 66% brix sugar maple syrup. The main problem with the classical way of collecting maple sap was that maple growers were unable to expand their business due to the huge workload required to harvest sap from trees. As a result, profitability of maple syrup productions was almost impossible to reach.

In the 70s, an alternative method of collecting maple sap has been developed. This alternative way involved collecting the sap from the maple trees using a tubing system, much the same way as in the dairy industry. This collection method was made possible thanks to spouts engaging notches of the trees and to a network of tubing and lines permanently installed on the entire sugar bush area and coupled to these spouts, where the sap of each of the maple trees is conveyed to a pumping station, which is then routed to the main sugar shack to be transformed into maple syrup. In many instances, the network of tubing is under vacuum, while in other instances the topography of the land allows the sap to descend by gravity to the pumping or harvesting station, thereby allowing the sap to be harvested in this way. Since they did not require a human presence as extensive as the classical bucket method, map sap collection systems allowed maple producers to significantly expand their businesses and make them much more profitable.

With years and with the help of scientific research, it has been shown that the yield per notch tends to be higher if the spout is changed annually and when sterile spouts are used during tapping. Different systems have thus been envisaged where different types of standard spouts are used or where adaptors are installed on the tip of the existing spouts, with the aim of optimizing production and installation before each year of production.

The problem with changing standard spouts is that the process requires cutting the tubes to which they are connected, as the connection between a spout and a corresponding tube tend to be very strong to ensure maintenance of the vacuum in the system and/or prevent leaks that may occur at the junction of the spout and the tube. Thus, year after year, the tubes connecting the various spouts to the line are reduced in length and ends up being at too short when they were cut several times. This results in the need of replacing some of the tubes at the time of annual notching, which translates in inefficiencies increased costs.

While such problems may be avoided by using adaptors mounted to the tips of the spouts, this solution is not completely satisfactory. Indeed, problems encountered with adaptors installed on the tip of the spouts include inadequate or insufficient sealing between the adaptor and the tips of the spouts (which creates a loss of vacuum in the overall system and/or leaks), and the difficulty of removing the adaptor from the spout at the end of the season (as both pieces have a very tight fit when notching which makes it more complex to uninstall). Other systems allowing for the rapid change of the adaptor are known, but sealing tends to remain unsatisfactory.

There is therefore a need for device for collecting sap, which would overcome at least one of the above-identified drawbacks.

### SUMMARY

According to a broad aspect, there is provided a device for collecting sap from a tapped hole in a tree and directing the sap to a sap collecting tube that is removably connectable to the device, the device comprising: tapping member extending along a longitudinal axis between a proximal end and a distal end, the tapping member comprising a first portion that is removably insertable into the tree and a second portion extending outside the tree when the first portion is inserted into the tapped hole; a connecting member comprising a connecting portion adapted to be mounted to the second portion of the tapping member and a fitting portion adapted to receive the sap collecting tube; a seal mounted between the second portion of the tapping member and the connecting portion of the connecting member; and securing means for locking the connecting member relative to the tapping member such that longitudinal movement of the connecting member is prevented; wherein, in use, the connecting member is mounted to the tapping member between first and second positions, wherein, in the second position, the seal provides a sealed connection between the tapping member and the connecting member.

According to another broad aspect, there is provided a device for collecting sap from a tapped hole in a tree and directing the sap to a sap collecting tube that is removably connectable to the device, the device comprising: a tapping member extending along a longitudinal axis between a proximal end and a distal end, the tapping member comprising outer and inner peripheral walls, the inner peripheral wall defining a first channel for conveying the sap, the tapping member comprising a first portion that is removably insertable into the tree and a second portion comprising a transversal projection extending transversely relative to the longitudinal axis; a connecting member comprising a connecting portion, a proximal end, a distal end, a body, and a fitting portion extending from the body transversely relative to the longitudinal axis and along a transversal axis, the inner peripheral wall defining a housing for receiving the second portion of the tapping member, the body comprising an inner peripheral wall defining a second channel in fluid communication with the first channel for conveying the sap, the fitting portion comprising outer and inner peripheral walls, the inner peripheral wall defining a third channel in fluid communication with the second channel for conveying the sap, the outer peripheral wall being adapted to receive the sap collecting tube, the outer peripheral wall of the connecting portion comprising a groove adjacent the distal end of the connecting member for receiving the transversal projection of the second portion of the tapping member; and a seal mounted between the second portion of the tapping member and the connecting portion of the connecting member; wherein, in use, the connecting member is mounted to the tapping member in a first position wherein the second portion of the tapping member is within the housing and the transversal projection is in an unlocked position in the groove for allowing longitudinal movement of the connecting member, and wherein, after rotation of the connecting member relative to the tapping member, the connecting member is in a second position wherein the transversal projection is in a locked position in the groove for preventing longitudinal movement of the connecting member.

According to a further broad aspect, there is provided a device for collecting sap from a tapped hole in a tree and directing the sap to a sap collecting tube that is removably connectable to the device, the device comprising: a tapping member extending along a longitudinal axis between a proximal end and a distal end, the tapping member comprising outer and inner peripheral walls, the inner peripheral wall defining a first channel for conveying the sap, the tapping member comprising a first portion that is removably insertable into the tree and a second portion comprising a transversal projection extending transversely relative to the longitudinal axis, wherein the second portion of the tapping member comprises a longitudinal projection extending longitudinally from the proximal end of the tapping member, wherein the longitudinal projection comprises outer and inner circular peripheral walls, wherein the inner circular peripheral wall defines a channel that is part of the first channel; a connecting member comprising a connecting portion, a proximal end, a distal end, a body, and a fitting portion extending from the body transversely relative to the longitudinal axis and along a transversal axis, the inner peripheral wall defining a housing for receiving the second portion of the tapping member, the body comprising an inner peripheral wall defining a second channel in fluid communication with the first channel for conveying the sap, the fitting portion comprising outer and inner peripheral walls, the inner peripheral wall defining a third channel in fluid communication with the second channel for conveying the sap, the outer peripheral wall being adapted to receive the sap collecting tube, the outer peripheral wall of the connecting portion comprising a groove adjacent the distal end of the connecting member for receiving the transversal projection of the second portion of the tapping member; and an annular seal mounted to the outer circular peripheral wall of the longitudinal projection; wherein, in use, the connecting member is mounted to the tapping member in a first position wherein the second portion of the tapping member is within the housing and the transversal projection is in an unlocked position in the groove for allowing longitudinal movement of the connecting member, and wherein, after rotation of the connecting member relative to the tapping member, the connecting member is in a second position wherein the transversal projection is in a locked position in the groove for preventing longitudinal movement of the connecting member and wherein the seal provides a sealed connection between the tapping member and the connecting member.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a first perspective view of a device for collecting sap in accordance with an embodiment;

FIG. 2 is a second perspective view of the device;

FIG. 3 is a top view of the device;

FIG. 4 is a side elevational view of the device;

FIG. 5 is a cross-sectional view taken along lines 5-5 of FIG. 3;

FIG. 6 is a cross-sectional view taken along lines 6-6 of FIG. 4;

FIG. 7 is a first exploded view of the device showing separately the connecting member, the seal and the tapping member;

FIG. 8 is a second exploded view of the device showing separately the connecting member and the seal mounted to the tapping member;

FIG. 9 is a side elevational view of the tapping member;

FIG. 10 is a perspective view of the tapping member;

FIG. 11 is a side elevational view of the connecting member;

FIG. 12 is an elevational view of the connecting member;

FIG. 13 is a perspective view of the connecting member;

FIG. 14 is a perspective view of the seal;

FIG. 15 is a cross-sectional view taken along lines 15-15 of FIG. 14;

FIGS. 16 and 17 are perspective views of the device showing the connecting member mounted to the tapping member in a first position wherein the connecting member is longitudinally movable with respect to the tapping member;

FIG. 18 is a perspective view of the device showing the connecting member mounted to the tapping member in the first position wherein the connecting member is longitudinally moved to abuts the tapping member;

FIG. 19 is a perspective view of the device showing the connecting member mounted to the tapping member in a second position wherein the connecting member is rotationally movable with respect to the tapping member; and

FIG. 20 is a perspective view of the device showing the connecting member mounted to the tapping member in the second position wherein the connecting member is rotationally moved with respect to the tapping member such that both transversal projections are in a locked position in both grooves for preventing longitudinal movement of the connecting member with respect to the tapping member.

### DETAILED DESCRIPTION OF EMBODIMENTS

In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. The use of “including,” “comprising,” or “having” and variations thereof herein is meant to encompass the items listed thereafter and equivalents thereof as well as additional suitable items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

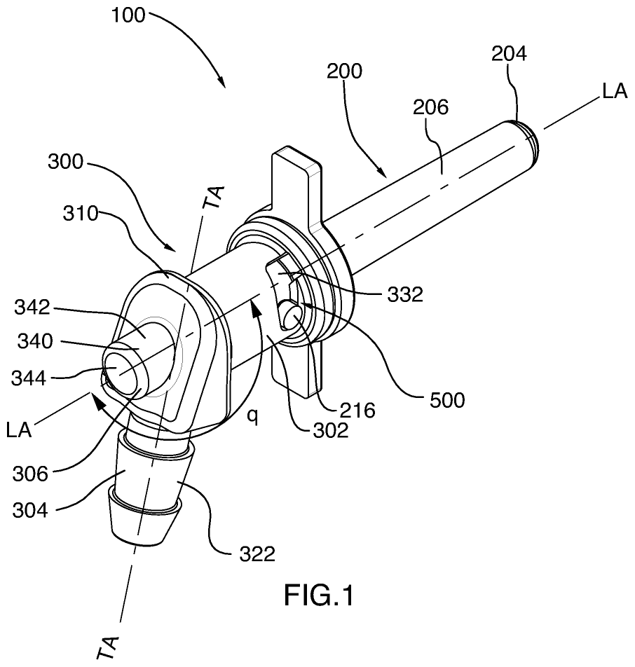

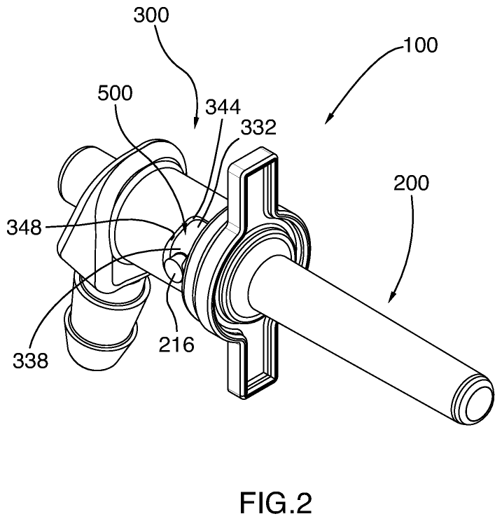

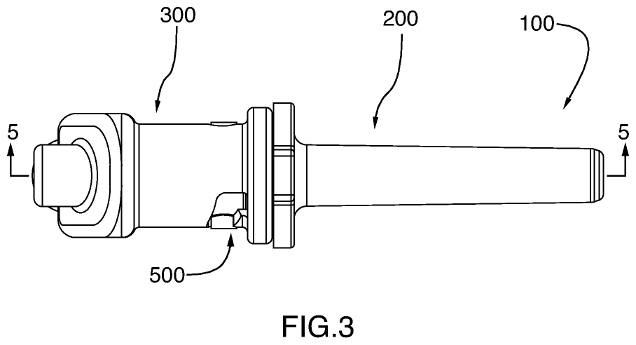

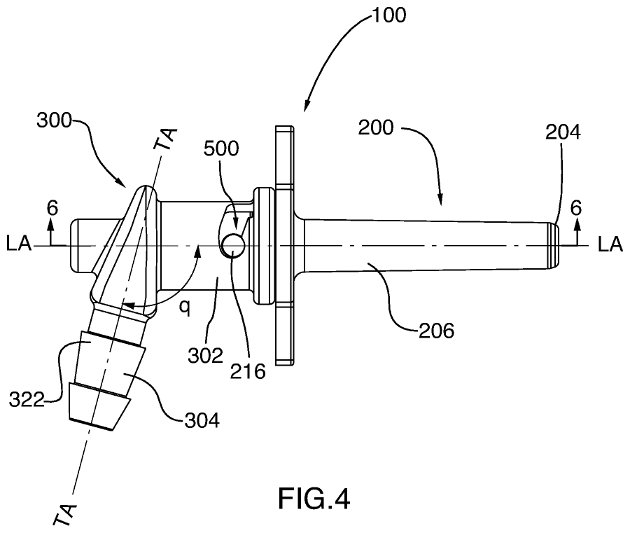

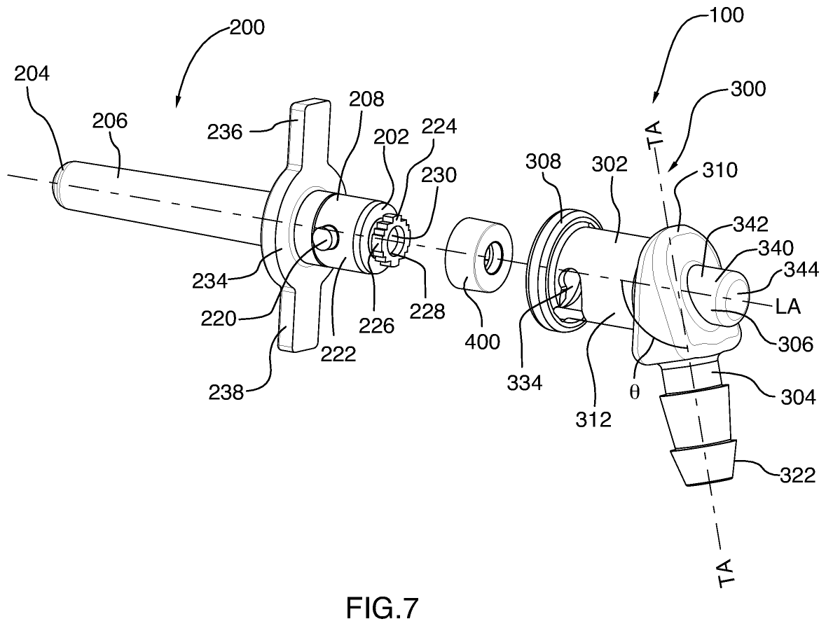

Variants, examples and preferred embodiments of the invention are described hereinbelow. FIGS. 1 to 8 show an example of a device 100 for collecting sap from a tapped hole in a tree (e.g., maple tree) and directing the sap to a sap collecting tube that is removably connectable to the device 100. The device 100 comprises a tapping member 200, a connecting member 300, a seal 400 and a securing means 500 for locking the connecting member 300 relative to the tapping member 200 such that longitudinal movement of the connecting member 300 is prevented.

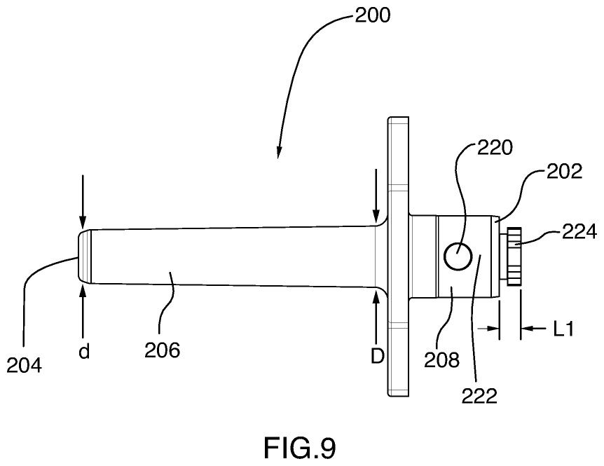

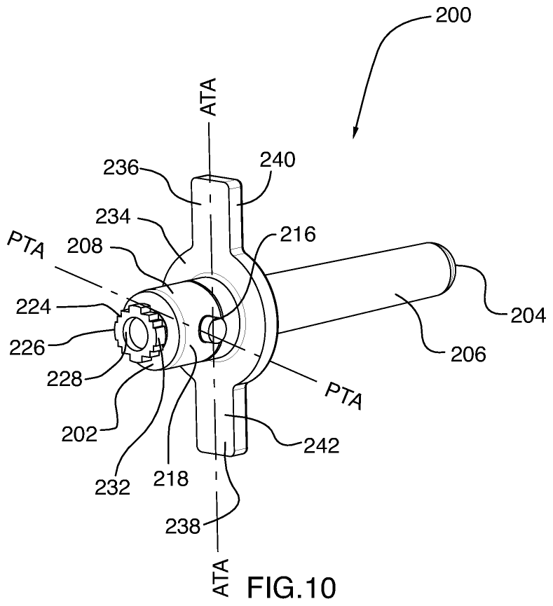

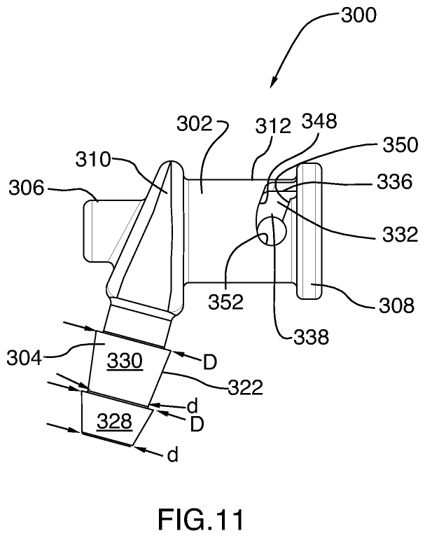

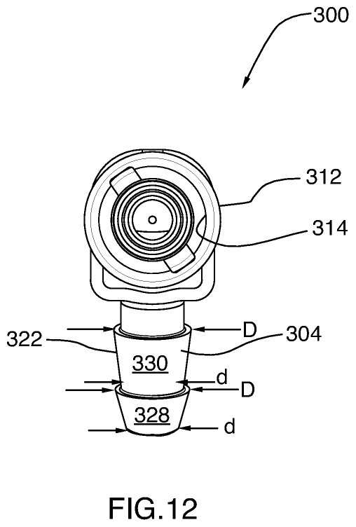

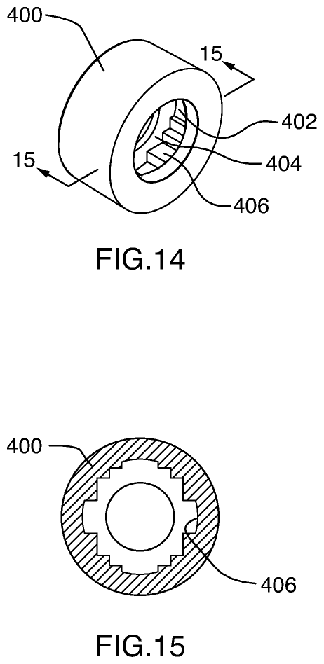

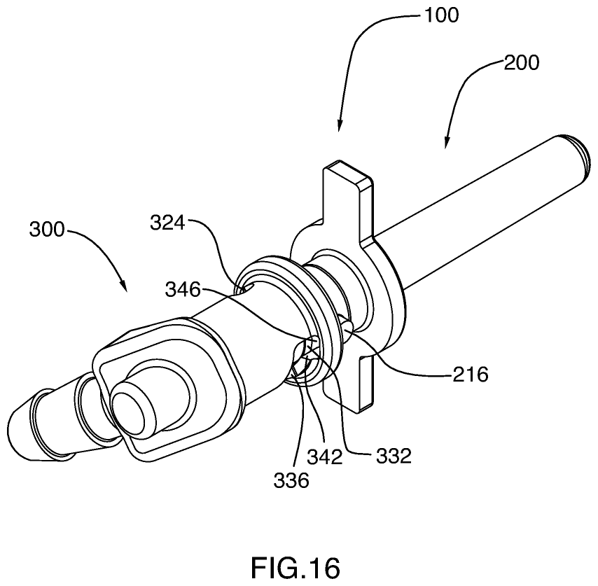

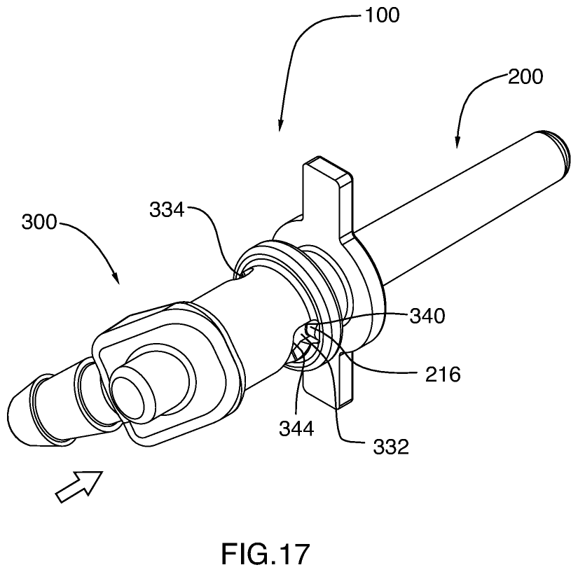

FIGS. 9 and 10 show features of the tapping member 200, FIGS. 11 to 13 show features of the connecting member 300 and FIGS. 14 and 15 show features of the seal 400. FIGS. 16 to 20 show the connecting member 300 mounted to the tapping member 200 in first and second positions.

The tapping member 200 extends along a longitudinal axis LA-LA between a proximal end 202 and a distal end 204, the tapping member 200 comprising a first portion 206 that is removably insertable into the tree and a second portion 208 extending outside the tree when the first portion 206 is inserted into the tree. In one variant, the first portion 206 of the tapping member 200 has an frustoconical shape with a proximal diameter D and a distal diameter d that is smaller than the proximal diameter D such that frictional engagement increases during insertion of the first portion 206 in the tree.

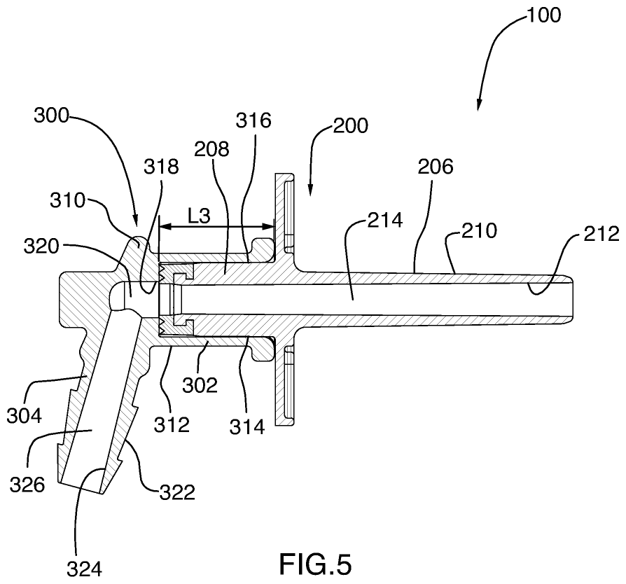

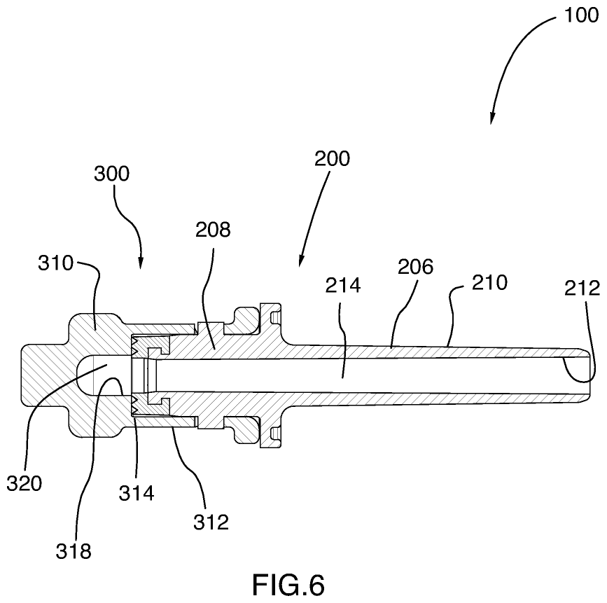

As best shown in FIGS. 5 and 6, the tapping member 200 comprises outer and inner peripheral walls 210, 212, the inner peripheral wall 212 defining a first channel 214 for conveying the sap.

The connecting member 300 comprises a connecting portion 302 adapted to be mounted to the second portion 208 of the tapping member 200, a proximal end 306, a distal end 308, a body 310 and a fitting portion 304 adapted to receive the sap collecting tube (not shown). The connecting portion 302 also comprises outer and inner peripheral walls 312, 314, the inner peripheral wall 314 defining a housing 316 for receiving the second portion 208 of the tapping member 200.

The fitting portion 304 extends transversely relative to the longitudinal axis LA-LA and along a transversal axis TA-TA. In one variant, the fitting portion 304 extends transversely and rearwardly from the body 310 relative to the connecting portion 302 and an angle Θ of about 90° to about 135° is defined between the longitudinal axis LA-LA and the transversal axis TA-TA. In use, the fitting portion 304 is directed towards the ground to allow sap to flow by gravity.

The body 310 comprises an inner peripheral wall 318 defining a second channel 320 in fluid communication with the first channel 214 for conveying the sap. Moreover, the fitting portion 304 comprises outer and inner peripheral walls 322, 324, the inner peripheral wall 324 defining a third channel 326 in fluid communication with the second channel 320 for conveying the sap. The first, second and third channels 214, 320, 326 may be circular channels.

In one variant, the outer peripheral wall 322 of the fitting portion 304 comprises a plurality of bards or first and second bards 328, 330 each having a frustoconical shape with a proximal diameter d and a distal diameter D that is larger than the proximal diameter d. As such, during insertion of the sap collecting tube over the fitting portion 304, the first and second bards 328, 330 each increases frictional engagement between the sap collecting tube and the fitting portion 304, and once the sap collecting tube is mounted to the fitting portion 304, the first and second bards 328, 330 each prevents unintentional movement of the sap collecting tube relative to the fitting portion 304.

The second portion 208 of the tapping member 200 comprises a first transversal projection 216 extending transversely relative to the longitudinal axis LA-LA from a first side 218 and a second transversal projection 220 extending transversely relative to the longitudinal axis LA-LA from a second side 222. In one variant, the first and second transversal projections 216, 220 extend along a projection transversal axis PTA-PTA.

The outer peripheral wall 312 of the connecting portion 302 comprises a first groove 332 adjacent the distal end 308 of the connecting member 300 for receiving the first transversal projection 216 of the second portion 208 of the tapping member 200 and a second groove 334 adjacent the distal end 308 of the connecting member 300 for receiving the second transversal projection 220 of the second portion 208 of the tapping member 200. The first and second projections 216, 220 and first and second grooves 332, 334 are part of the securing means 500.

In use, the connecting member 300 is mounted to the tapping member 200 in a first position wherein the second portion 208 of the tapping member 200 is within the housing 316 and the first and second transversal projections 216, 220 are each in an unlocked position in the first and second grooves 332, 334 for allowing longitudinal movement of the connecting member 300 relative to the tapping member 200. And, after rotation of the connecting member 300 relative to the tapping member 200, the connecting member 300 is in a second position wherein the first and second transversal projections 216, 220 are each in a locked position in the first and second grooves 332, 334 for preventing longitudinal movement of the connecting member 300 relative to the tapping member 200.

The second portion 208 of the tapping member 200 also comprises a longitudinal projection 224 extending longitudinally from the proximal end 202 of the tapping member 200. Referring to FIG. 9, the longitudinal projection 224 extends rearwardly from the proximal end 202 along the longitudinal axis LA-LA and has a length L1 for allowing the seal 400 to be mounted to the longitudinal projection 224.

The longitudinal projection 224 comprises outer and inner peripheral walls 226, 228, wherein the inner peripheral wall 228 defines a channel 230 that is part of the first channel 214.

In one variant, the seal 400 is mechanically affixed to the longitudinal projection 224. In another variant, the seal 400 is chemically bonded to the longitudinal projection 224. In a further variant, the seal 400 is overmolded onto the longitudinal projection 224.

In the second position, the seal 400 provides a sealed connection between the tapping member 200 and the connecting member 300. The seal 400 may be an annular seal with an inner peripheral wall 402 defining an opening 404 for receiving the longitudinal projection 224.

The seal 400 may be made of a compressible material such that the seal 400 is compressed between the tapping member 200 and the connecting member 300 when the connecting member 300 is in the second position.

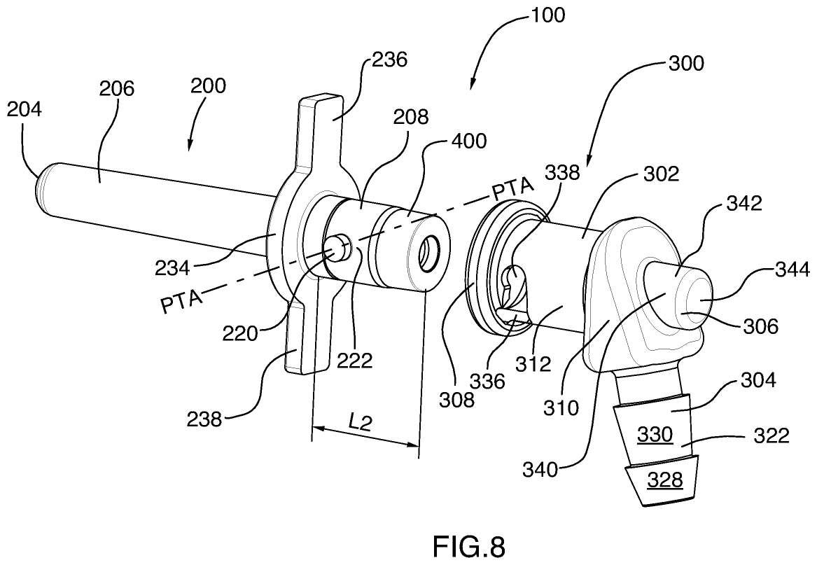

Referring to FIG. 8, when the seal 400 is mounted to the second portion 208, the second portion 208 and the seal 400 has a length L2.

Referring to FIG. 5, the housing 316 has a length L3 that is sufficient for receiving the second portion 208 and the seal 400 when the connecting member 300 is in the second position.

If the seal 400 is made of a compressible material, the length L3 may be smaller or slightly smaller than the length L2 such that the seal 400 is compressed when the connecting member 300 is mounted to the tapping member 200 in the second position.

The inner peripheral wall 402 of the seal 400 may also comprise a plurality of internal notches 406 and the longitudinal projection 224 may comprise a plurality of corresponding external projections 232 such that the external projections 230 are received in the internal notches 406 and such that the seal 400 is mechanically affixed to the longitudinal projection 224.

Each of the first and second grooves 332, 334 comprises a first groove portion 336 extending longitudinally and a second groove portion 338 extending transversely, wherein in the unlocked position, the transversal projection 216; 220 is in the first groove portion 336, and wherein in the locked position, the transversal projection 216; 220 is in the second groove portion 338.

As best shown in FIGS. 16 and 17, the first groove portion 336 is defined by first and second longitudinal walls 340, 342 and proximal and distal end walls 344, 346.

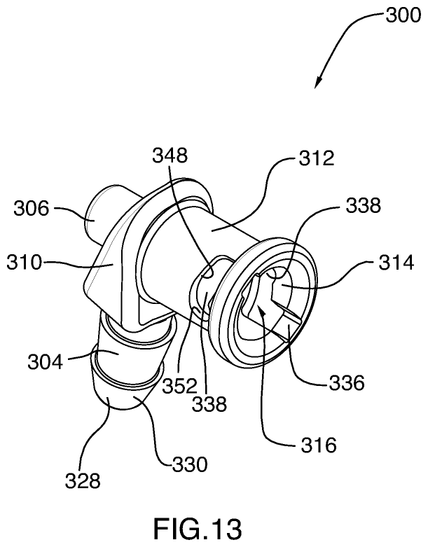

As best shown in FIGS. 11 and 13, the second groove portion 338 is defined by first and second transversal walls 348, 350 and an end wall 352.

Each of the first and second grooves 332, 334 may have a substantially L-shape or C-shape.

The second portion 208 of the tapping member 200 may comprise a flange 232 extending transversely and comprising an annular portion 234, a first arm 236 and a second opposed arm 238, the first and second arms 236, 238 comprising first and second gripping portion 240, 242 each allowing a hand of a user to grasp the gripping portion to carry the device 100 or to remove the device 100 from the tree. In one variant, the first and second arms 236, 238 extend along an arm transversal axis ATA-ATA.

The body 310 of the connecting portion 302 comprises a proximal projection 340 extending rearwardly longitudinally from the body 310 and along the longitudinal axis LA-LA. The proximal projection 340 comprises an outer peripheral wall 342 and a pounding wall 344 for allowing the user to hit the pounding wall 344 for inserting the tapping member 200 in the tree.

The tapping member 200 and the connecting member 300 may be made of a rigid material, such as nylon, polycarbonate materials, thermoplastics, or thermosetting resins, reinforced thermoplastics, or reinforced thermosetting resins, polyethylene, polypropylene, or any other suitable material. The tapping member 200 may be made of stainless steel (Grade 304 for instance).

The seal 400 may be made of thermoplastic polyurethane, elastomer, rubber, styrene-butadiene rubber, silicone rubber, or any other suitable material.

In the variant wherein the seal 400 is overmolded onto the longitudinal projection 224, the longitudinal projection 224 may be made of polyethylene 2907, PEBAX™ 7233 or polypropylene 7633U T14 and the seal 400 may be made of polyethylene MD50, PEBAX™ 5533 or polypropylene 7633U.

As shown in FIGS. 16 and 17, in the first position, the connecting member 300 is longitudinally movable with respect to the tapping member 200 for allowing the user to mount the connecting member 300 to the tapping member 200 by longitudinally moving the connecting member 300 relative to the tapping member 200 while the first and second projections 216, 220 are each moving in the first groove portion 336 of the respective first and second grooves 332, 334.

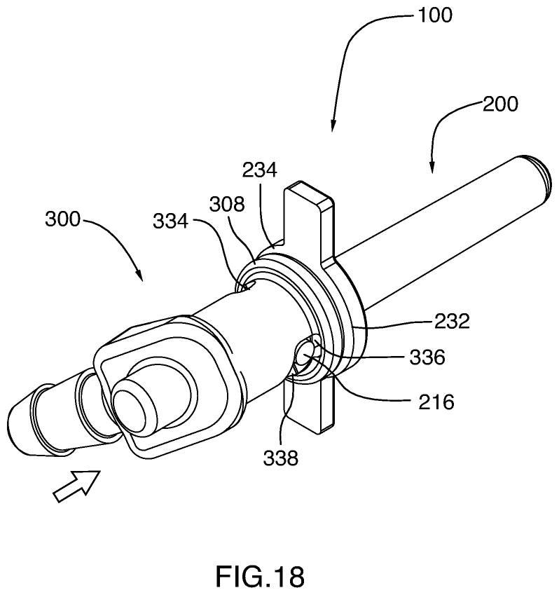

As shown in FIG. 18, in the first position, the user longitudinally moves the connecting member 300 relative to the tapping member 200 while the first and second projections 216, 220 are each moving in the first groove portion 336 of the first and second grooves 332, 334 for each abutting against the proximal end wall 344 of the first groove portion 336 wherein the distal end 308 of the connecting member 300 abuts against the annular portion 234 of the flange 232 of the tapping member 200.

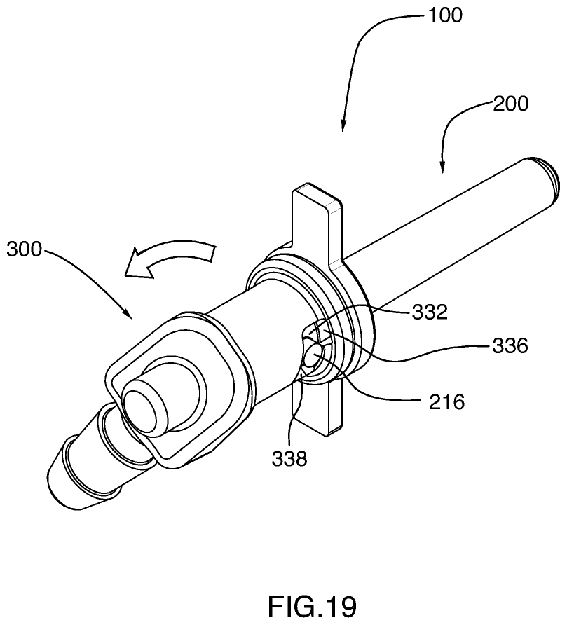

As shown in FIG. 19, the connecting member 300 is rotationally movable with respect to the tapping member 200 for allowing the user to pivot the connecting member 300 in the second position relative to the tapping member 200 while the first and second projections 216, 220 are each moving in the second groove portion 338 of the respective first and second grooves 332, 334.

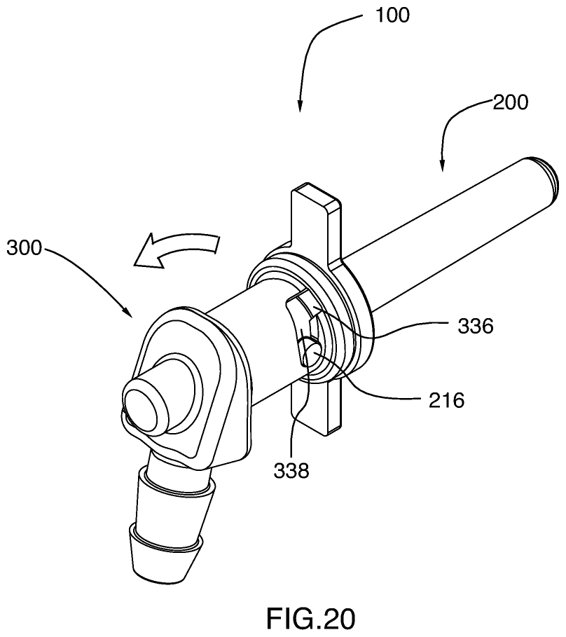

As shown in FIG. 20, in the second position, the user pivots the connecting member 300 relative to the tapping member 200 while the first and second projections 216, 220 are each moving in the second groove portion 338 of the respective first and second grooves 332, 334 for each abutting against the end wall 352 of the second groove portion 338 such that the first and second transversal projections 216, 220 are in a locked position in the first and second grooves 332, 334 for preventing longitudinal movement of the connecting member 300 with respect to the tapping member 200. Once rotation is completed and each projection abuts against the end wall, the connecting member 300 is mounted to the tapping member 200 in the second position wherein the seal 400 provides a sealed connection between the tapping member 200 and the connecting member 300. It is understood that once each transversal projection is in the locked position in the second groove portion 338 and is no longer in the first groove portion 336, the seal 400 provides the sealed connection between the tapping member 200 and the connecting member 300 and longitudinal movement of the connecting member 300 with respect to the tapping member 200 is prevented.

The above description of the variants, examples or embodiments should not be interpreted in a limiting manner since other variations, modifications and refinements are possible within the scope of the present invention. Accordingly, it should be understood that various features and aspects of the disclosed variants or embodiments can be combined with or substituted for one another in order to form varying modes of the disclosed invention. For example, and without limitation, any individual element of the described variants or embodiments may be replaced by alternative elements that provide substantially similar functionality or otherwise provide adequate operation. This includes, for example, presently known alternative elements, such as those that might be currently known to a skilled person in the art, and alternative elements that may be developed in the future, such as those that a skilled person in the art might, upon development, recognize as an alternative. The scope is defined in the appended claims and their equivalents.

1. A device for collecting sap from a tapped hole in a tree and directing the sap to a sap collecting tube that is removably connectable to the device, the device comprising:
a tapping member extending along a longitudinal axis between a proximal end and a distal end, the tapping member comprising a first portion that is removably insertable into the tree and a second portion extending outside the tree when the first portion is inserted into the tree;
a connecting member comprising a connecting portion adapted to be mounted to the second portion of the tapping member and a fitting portion adapted to receive the sap collecting tube;
a seal mounted between the second portion of the tapping member and the connecting portion of the connecting member; and
securing means for locking the connecting member relative to the tapping member such that longitudinal movement of the connecting member is prevented;
wherein, in use, the connecting member is mounted to the tapping member between first and second positions, wherein, in the second position, the seal provides a sealed connection between the tapping member and the connecting member.

2. The device of claim 1, wherein the tapping member comprises outer and inner peripheral walls, the inner peripheral wall defining a first channel for conveying the sap, wherein the connecting member comprises a body and outer and inner peripheral walls, the inner peripheral wall defining a housing for receiving the second portion of the tapping member, the body comprising an inner peripheral wall defining a second channel in fluid communication with the first channel for conveying the sap, and wherein the fitting portion comprises outer and inner peripheral walls, the inner peripheral wall defining a third channel in fluid communication with the second channel for conveying the sap, the outer peripheral wall being adapted to receive the sap collecting tube.

3. The device of claim 2, wherein the securing means comprises a transversal projection extending transversely relative to the longitudinal axis from the second portion of the tapping member and a groove in the outer peripheral wall of the connecting portion adjacent a distal end of the connecting member for receiving the transversal projection, wherein, in use, in the first position, the second portion of the tapping member is within the housing and the transversal projection is in an unlocked position in the groove for allowing longitudinal movement of the connecting member, and wherein, after rotation of the connecting member relative to the tapping member, the connecting member is in the second position wherein the transversal projection is in a locked position in the groove for preventing longitudinal movement of the connecting member.

4. The device of claim 1, wherein the second portion of the tapping member comprises a longitudinal projection extending longitudinally from the proximal end of the tapping member, wherein the longitudinal projection comprises outer and inner circular peripheral walls, wherein the inner circular peripheral wall defines a channel that is part of the first channel, wherein the seal is an annular seal mounted to the outer circular peripheral wall of the longitudinal projection.

5. The device of claim 4, wherein the annular seal is made of a compressible material and wherein the annular seal is compressed in the second position.

6. The device of claim 3, wherein the groove comprises a first groove portion extending longitudinally and a second groove portion extending transversely, wherein in the unlocked position, the transversal projection is in the first groove portion, and wherein in the locked position, the transversal projection is in the second groove portion.

7. The device of claim 3, wherein the transversal projection is a first transversal projection on a first side of the second portion of the tapping member and the second portion of the tapping member comprises a second transversal projection extending transversely relative to the longitudinal axis from a second side of the second portion of the tapping member, wherein the groove is a first groove on a first side of the outer peripheral wall of the connecting portion and the outer peripheral wall of the connecting portion comprises a second groove on a second side of the outer peripheral wall of the connecting portion, wherein, in use, in the first position, the second portion of the tapping member is within the housing and the second transversal projection is in an unlocked position in the second groove for allowing longitudinal movement of the connecting member, and wherein, after rotation of the connecting member relative to the tapping member, the connecting member is in the second position wherein the second transversal projection is in a locked position in the second groove for preventing longitudinal movement of the connecting member.

8. A device for collecting sap from a tapped hole in a tree and directing the sap to a sap collecting tube that is removably connectable to the device, the device comprising:
a tapping member extending along a longitudinal axis between a proximal end and a distal end, the tapping member comprising outer and inner peripheral walls, the inner peripheral wall defining a first channel for conveying the sap, the tapping member comprising a first portion that is removably insertable into the tree and a second portion comprising a transversal projection extending transversely relative to the longitudinal axis;
a connecting member comprising a connecting portion, a proximal end, a distal end, a body, and a fitting portion extending from the body transversely relative to the longitudinal axis and along a transversal axis, the connecting portion comprising outer and inner peripheral walls, the inner peripheral wall defining a housing for receiving the second portion of the tapping member, the body comprising an inner peripheral wall defining a second channel in fluid communication with the first channel for conveying the sap, the fitting portion comprising outer and inner peripheral walls, the inner peripheral wall defining a third channel in fluid communication with the second channel for conveying the sap, the outer peripheral wall being adapted to receive the sap collecting tube, the outer peripheral wall of the connecting portion comprising a groove adjacent the distal end of the connecting member for receiving the transversal projection of the second portion of the tapping member; and
a seal mounted between the second portion of the tapping member and the connecting portion of the connecting member;
wherein, in use, the connecting member is mounted to the tapping member in a first position wherein the second portion of the tapping member is within the housing and the transversal projection is in an unlocked position in the groove for allowing longitudinal movement of the connecting member, and wherein, after rotation of the connecting member relative to the tapping member, the connecting member is in a second position wherein the transversal projection is in a locked position in the groove for preventing longitudinal movement of the connecting member.

9. The device of claim 8, wherein, in the second position, the seal provides a sealed connection between the tapping member and the connecting member.

10. The device of claim 9, wherein the second portion of the tapping member comprises a longitudinal projection extending longitudinally from the proximal end of the tapping member, wherein the longitudinal projection comprises outer and inner circular peripheral walls, wherein the inner circular peripheral wall defines a channel that is part of the first channel, and wherein the seal is an annular seal mounted to the outer circular peripheral wall of the longitudinal projection.

11. The device of claim 10, wherein the annular seal is made of a compressible material and wherein the annular seal is compressed in the second position.

12. The device of claim 10, wherein the annular seal comprises a plurality of internal notches and the longitudinal projection comprises a plurality of external projections and wherein the external projections are received in the internal notches.

13. The device of claim 10, wherein the annular seal is mechanically affixed to the longitudinal projection, chemically bonded to the longitudinal projection, or overmolded onto the longitudinal projection.

14. The device of claim 8, wherein the groove comprises a first groove portion extending longitudinally and a second groove portion extending transversely, wherein in the unlocked position, the transversal projection is in the first groove portion, and wherein in the locked position, the transversal projection is in the second groove portion.

15. The device of claim 8, wherein the transversal projection is a first transversal projection on a first side of the second portion of the tapping member and the second portion of the tapping member comprises a second transversal projection extending transversely relative to the longitudinal axis from a second side of the second portion of the tapping member, wherein the groove is a first groove on a first side of the outer peripheral wall of the connecting portion and the outer peripheral wall of the connecting portion comprises a second groove on a second side of the outer peripheral wall of the connecting portion, wherein, in use, in the first position, the second portion of the tapping member is within the housing and the second transversal projection is in an unlocked position in the second groove for allowing longitudinal movement of the connecting member, and wherein, after rotation of the connecting member relative to the tapping member, the connecting member is in the second position wherein the second transversal projection is in a locked position in the second groove for preventing longitudinal movement of the connecting member.

16. A device for collecting sap from a tapped hole in a tree and directing the sap to a sap collecting tube that is removably connectable to the device, the device comprising:
a tapping member extending along a longitudinal axis between a proximal end and a distal end, the tapping member comprising outer and inner peripheral walls, the inner peripheral wall defining a first channel for conveying the sap, the tapping member comprising a first portion that is removably insertable into the tree and a second portion comprising a transversal projection extending transversely relative to the longitudinal axis, wherein the second portion of the tapping member comprises a longitudinal projection extending longitudinally from the proximal end of the tapping member, wherein the longitudinal projection comprises outer and inner circular peripheral walls, wherein the inner circular peripheral wall defines a channel that is part of the first channel;
a connecting member comprising a connecting portion, a proximal end, a distal end, a body, and a fitting portion extending from the body transversely relative to the longitudinal axis and along a transversal axis, the connecting portion comprising outer and inner peripheral walls, the inner peripheral wall defining a housing for receiving the second portion of the tapping member, the body comprising an inner peripheral wall defining a second channel in fluid communication with the first channel for conveying the sap, the fitting portion comprising outer and inner peripheral walls, the inner peripheral wall defining a third channel in fluid communication with the second channel for conveying the sap, the outer peripheral wall being adapted to receive the sap collecting tube, the outer peripheral wall of the connecting portion comprising a groove adjacent the distal end of the connecting member for receiving the transversal projection of the second portion of the tapping member; and
an annular seal mounted to the outer circular peripheral wall of the longitudinal projection;
wherein, in use, the connecting member is mounted to the tapping member in a first position wherein the second portion of the tapping member is within the housing and the transversal projection is in an unlocked position in the groove for allowing longitudinal movement of the connecting member, and wherein, after rotation of the connecting member relative to the tapping member, the connecting member is in a second position wherein the transversal projection is in a locked position in the groove for preventing longitudinal movement of the connecting member and wherein the annular seal provides a sealed connection between the tapping member and the connecting member.

17. The device of claim 16, wherein the annular seal is made of a compressible material and wherein the annular seal is compressed in the second position.

18. The device of claim 16, wherein the annular seal comprises a plurality of internal notches and the longitudinal projection comprises a plurality of external projections and wherein the external projections are received in the internal notches.

19. The device of claim 16, wherein the annular seal is mechanically affixed to the longitudinal projection, chemically bonded to the longitudinal projection, or overmolded onto the longitudinal projection.

20. The device of claim 16, wherein the groove comprises a first groove portion extending longitudinally and a second groove portion extending transversely, wherein in the unlocked position, the transversal projection is in the first groove portion, and wherein in the locked position, the transversal projection is in the second groove portion.

21. The device of claim 16, wherein the transversal projection is a first transversal projection on a first side of the second portion of the tapping member and the second portion of the tapping member comprises a second transversal projection extending transversely relative to the longitudinal axis from a second side of the second portion of the tapping member, wherein the groove is a first groove on a first side of the outer peripheral wall of the connecting portion and the outer peripheral wall of the connecting portion comprises a second groove on a second side of the outer peripheral wall of the connecting portion, wherein, in use, in the first position, the second portion of the tapping member is within the housing and the second transversal projection is in an unlocked position in the second groove for allowing longitudinal movement of the connecting member, and wherein, after rotation of the connecting member relative to the tapping member, the connecting member is in the second position wherein the second transversal projection is in a locked position in the second groove for preventing longitudinal movement of the connecting member.
